(19) United States
(12) Patent Application Publication
(10) Pub. No.: US 2023/0239727 A1
(43) Pub. Date: Jul. 27, 2023

(54) METHOD FOR PREDICTIVELY OPERATING A COMMUNICATION NETWORK

(71) Applicant: Deutsche Telekom AG, Bonn (DE)

(72) Inventors: Bangnan Xu, Darmstadt (DE); Georg Seul, Cologne (DE); Richard Weiler, Berlin (DE); Nico Bayer, Bad Nauheim (DE)

(21) Appl. No.: 18/156,420

(22) Filed: Jan. 19, 2023

(30) Foreign Application Priority Data
Jan. 21, 2022 (EP) 22 152 727.8

(51) Int. Cl. H04W 28/02; H04W 28/26

(52) U.S. Cl. CPC H04W 28/0268; H04W 28/26

(57) ABSTRACT

A method for operating a communication network includes: receiving, by a business support system of a resource reservation system, a reservation request, the reservation request indicating a Quality of Service (QoS) for an upcoming connection to be provided at a time distance from a reservation by the communication network for a terminal device and an application or service accessed by the terminal device via the upcoming connection; checking, by a bookkeeper decision engine of the resource reservation system, whether the business support system has availability for the indicated QoS; in response to confirming the availability for the indicated QoS, sending, by the bookkeeper decision engine, a reservation confirmation; and providing, by the communication network, the upcoming connection with the indicated QoS assigned for the terminal device at the time distance from the reservation.

### CROSS-REFERENCE TO PRIOR APPLICATIONS

Priority is claimed to European Patent Application No. EP 22 152 727.8, filed on Jan. 21, 2022, the entire disclosure of which is hereby incorporated by reference herein.

### FIELD

The invention relates to a method for operating a communication network wherein the communication network provides a connection with a quality of service (QoS) assigned for a terminal device. The invention further relates to a resource reservation system for a communication network and a computer program product.

### BACKGROUND

A communication network, e.g. a cellular network, provides connections, e.g. wireless connections, for an increasing plurality of terminal devices. The terminal devices connect to the communication network for accessing an increasing number of applications or services which respectively require an increasing quality of service (QoS), e.g. a minimum latency and/or a maximum bitrate, to be assigned to the corresponding connection.

The higher the QoS assigned to the connection is, the larger an amount of spectral resources, i.e. radio resources, to be allocated to the connection by the communication network is. For instance, a sports broadcasting service comprising a plurality of cameras or an advanced video production service, particularly when being accessed simultaneously by a plurality of terminal devices, require the communication network to allocate large amounts of spectral resources to the connections thereof.

The plurality of terminal devices competes for available spectral resources of the communication network in every single moment. However, the available spectral resources are limited. As a consequence, the communication network either refuses a connection or assigns a lower QoS, i.e. an insufficient QoS, to a connection when the QoS required by the connection is currently not available and, hence, cannot be assigned thereto.

In other words, the communication network does not reliably provide connections with the required QoS assigned. As a consequence, users of the terminal devices and providers of the applications or services may suffer from bad experiences.

### SUMMARY

In an exemplary embodiment, the present invention provides a method for operating a communication network. The method includes: receiving, by a business support system of a resource reservation system, a reservation request, the reservation request indicating a Quality of Service (QoS) for an upcoming connection to be provided at a time distance from a reservation by the communication network for a terminal device and an application or service accessed by the terminal device via the upcoming connection; checking, by a bookkeeper decision engine of the resource reservation system, whether the business support system has availability for the indicated QoS; in response to confirming the availability for the indicated QoS, sending, by the bookkeeper decision engine, a reservation confirmation; and providing, by the communication network, the upcoming connection with the indicated QoS assigned for the terminal device at the time distance from the reservation.

### BRIEF DESCRIPTION OF DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 schematically shows an entity diagram of a resource reservation system according to the invention for a communication network.

### DETAILED DESCRIPTION

Exemplary embodiments of the invention provide a method for operating a communication network which allows for the communication network to reliably allocate spectral resources to connections of terminal devices. Exemplary embodiments of the invention further provide a communication network and a computer program product.

One aspect of the invention is a method for operating a communication network wherein the communication network provides a connection with a QoS assigned for a terminal device. The terminal device executes an application or uses a service accessible via the connection and requires the QoS to be assigned to the connection by the communication network. The terminal device may be configured as a smartphone, a tablet, a notebook, a desktop computer and the like.

According to the invention, a business support system (BSS) of a resource reservation system receives a reservation request, the reservation request indicating a QoS for an upcoming connection to be provided by the communication network for the terminal device and an application or service accessed by the terminal device via the upcoming connection. The business support system has an availability of the indicated QoS for the upcoming connection checked by a bookkeeper decision engine (BDE) of the resource reservation system and sends a reservation confirmation when the availability of the indicated QoS is confirmed by the bookkeeper decision engine, and the communication network will assign the indicated QoS to the upcoming connection of the terminal device. The upcoming connection is provided by the communication network for the terminal device after the reservation, i.e. at a time distance from the reservation. The reservation request allows for blocking spectral resources of the communication network in advance.

It is noted that the terms “business support system”, “bookkeeper decision engine” and further terms used herein for addressing an entity do not limit the scope of the protection. Rather, the terms used herein are defined by the respective roles within the method according to exemplary embodiments of the invention.

The business support system and the bookkeeper decision engine help to make sure that the required QoS will be assigned and the required spectral resources will be allocated by the communication network to the upcoming connection of the terminal device, i.e. at a future time. The reservation request relates to or addresses a later spectral state of the communication network independently from a current spectral state of the communication network at the time of reservation. That means that the reservation request addresses a resource availability of the communication network at the time the spectral resources are actually needed.

The business support system may comprise a customer portal, i.e. a frontend, a user may log into, e.g. for selecting the application or service accessed by the terminal device via the upcoming connection and causing the reservation request to be sent. The user may handle the customer portal via said terminal device or via a different terminal device.

The bookkeeper decision engine enables the communication network to prospectively plan an allocation of spectral resources, i.e. radio resources (RR), to connections of terminal devices. Accordingly, a user of the terminal device and a provider of an application or service trust in the upcoming connection when the reservation confirmation is received.

The business support system may send a reservation offer when the availability of the indicated QoS is not confirmed, the reservation offer indicating an available lower QoS for the upcoming connection. The reservation offer may be accepted as the reservation confirmation, and the application or the service may be adjusted accordingly, for instance by configuring a higher latency or a lower bitrate. The communication network will assign the lower QoS to the upcoming connection of the terminal device instead of the indicated QoS. Accordingly, the user of the terminal device and the provider of the application or service trust in the upcoming connection when the reservation offer is accepted.

In an embodiment, the reservation request, the reservation confirmation and the reservation offer are transmitted using a dedicated protocol and/or at a specific QoS. The dedicated protocol supports any communication within the resource reservation system. The specific QoS allows for a high priority of the communication related to QoS reservation.

The reservation request preferably indicates a time of the upcoming connection, a location of the terminal device at the indicated time and/or a number of upcoming connections requiring the indicated QoS. The indicated time may comprise a start time, an end time and/or a duration of the upcoming connection. The location may comprise an indication of a radio cell the terminal device will be arranged in and/or a position of the terminal device within a radio cell the terminal device will be arranged in for the upcoming connection. The number of upcoming connections indicates a number of terminal devices simultaneously accessing the application or service at the indicated time. Said additional indications allow the bookkeeper decision engine to precisely check an availability of the indicated QoS for the upcoming connection.

Having the availability checked preferably comprises sending an availability request to the bookkeeper decision engine via a service management and orchestration (SMO) engine of the resource reservation system, the availability request comprising indications of the reservation request, and receiving an availability confirmation from the bookkeeper decision engine via the service management and orchestration engine when the bookkeeper decision engine finds an availability of the indicated QoS. The service management and orchestration engine substantially forwards the indications of the reservation request and the availability confirmation from the business support system to the bookkeeper decision engine and vice versa.

Additionally, the service management and orchestration engine may assign the indicated QoS to the upcoming connection, e.g. instantiate a slice of the communication network for the upcoming connection or allow for a higher priority of the upcoming connection, and notify the successful instantiation to the business support system and/or the bookkeeper decision engine.

In an embodiment, finding the availability comprises sending a QoS prediction request to a QoS prediction service (pQoS) of the communication network and receiving a QoS prediction report from the QoS prediction service, the QoS prediction request comprising indications of the availability request and the QoS prediction report indicating a highest available QoS, a determined number of resource blocks (RB), the number depending on an achievable throughput per resource block, required for the indicated QoS, a total number of resource blocks and a number of free resource blocks at the location of the terminal device. A resource block is a smallest physical spectral unit to be allocated to a connection.

The QoS prediction service predicts a load of the communication network and evaluates an availability of spectral resources at the time of the upcoming connection and at the location of the terminal device at the time of the upcoming connection.

The bookkeeper decision engine or the QoS prediction service may determine the number of resource blocks required for the indicated QoS dependent of the location of the terminal device and a device capability of the terminal device via an estimation or a calculation. The bookkeeper decision engine or the QoS prediction service may take into account local conditions of a radio cell the terminal device will be arranged in at the time of the upcoming connection, e.g. geographical conditions of or a possible density of terminal devices being simultaneously arranged in the radio cell. The bookkeeper decision service or the QoS prediction service may further take into account a configuration of the terminal device, e.g. a maximum sending bit rate or a maximum reception bit rate. The more information is used by the bookkeeper decision engine or the QoS prediction service the more accurate is the determined number of resource blocks. Full information enables calculating the number of resource blocks. Little information requires estimating the number of required resource blocks.

Preferably, a capacity usage policy manager of the resource reservation system provides the bookkeeper decision engine with a capacity usage policy and the bookkeeper decision engine finds the availability by applying the provided capacity usage policy to the QoS prediction report. The capacity usage policy manager is configured for enforcing a style of handling the total number of available resource blocks provided by the communication network. The style of handling is defined by the capacity usage policy provided for the bookkeeper decision engine. The capacity usage policy may comprise a plurality of availability rules. Applying the provided capacity usage policy may comprise checking a conformity of the indications comprised by the QoS prediction report with the capacity usage policy.

Particularly, the capacity usage policy manager selects the capacity usage policy dependent of the indicated application and provides the selected capacity usage policy. The capacity usage policy manager comprises a plurality of different capacity usage policies. The plurality of different capacity usage policies allows for different applications and services to be treated differently with respect to QoS reservation. A flexibility of the communication network in allocating spectral resources to upcoming connections is increased.

The bookkeeper decision engine may find the availability when the calculated number of the resource blocks required for the indicated QoS is lower than a predetermined first percentage of free resource blocks and a number of reserved resource blocks is lower than a predetermined second percentage of available resource blocks, the first percentage and the second percentage being defined by availability rules of the capacity usage policy. The first and second percentages both avoid an overly reservation of resource blocks. The first percentage ensures a sufficient availability of resource blocks for a best effort traffic, while the second percentage limits the reservation of resource blocks.

The bookkeeper decision engine may store reservation data corresponding to the indications of the availability request in a reservation database of the resource reservation system first, e.g. after confirming the availability, as temporary and second, upon a reservation confirmation received from the business support system, as final. Entries of the reservation database correspond to reservations of spectral resources. The temporary storage prevents the confirmed available resource blocks from being simultaneously reserved otherwise during the reservation process. The final storage, upon the reservation confirmation, excludes the reserved resource blocks from the available resource blocks.

Advantageously, assigning the indicated QoS comprises authorizing the terminal device via a subscriber identity module (SIM) of the terminal device. The communication network authorizes the terminal device when providing the upcoming connection. However, an unauthorized terminal device may use reserved resource blocks not being used by the authorized terminal. Authorized terminal devices, i.e. terminal devices indicated by the confirmation request, primarily benefit from the reserved resource blocks but do not prevent a best effort use of the reserved resource blocks.

Another aspect of the invention is a resource reservation system comprising a business support system. Communication networks with a business support system are commonly used. Hence, there are many possible applications for the invention.

According to the invention, the communication network comprises a bookkeeper decision engine and the communication network is configured for carrying out a method according to the invention. The bookkeeper decision engine is a central network entity enabling the communication network for participating in the method according to exemplary embodiments of the invention. Due to the bookkeeper decision engine, the communication network is enabled to reliably allocate spectral resources to an upcoming connection of a terminal device.

Still another aspect of the invention is a computer program product for a computing device, the computer program product comprising a storage medium storing a program code readable by the computing device. The storage medium may comprise a CD, a DVD, an USB device, a hard disk, a solid state disk, a disk array, a RAM chip, an internet cloud and the like.

According to the invention, the program code causes the computing device to participate in a method according to the invention as a business support system, a service management and orchestration engine, a bookkeeper decision engine, a QoS prediction service or a capacity usage policy manager of a resource reservation system according to the invention when being executed by a processor of the computing device. The computer program product enables the computing device to participate in the method according to exemplary embodiments of the invention as a required entity or as an optional entity.

Preferably, the program code implements a QoS reservation Application Programming Interface (API) for the service management and orchestration engine, a capacity usage policy API for the capacity usage policy manager and/or a QoS prediction API for the QoS prediction service, the bookkeeper decision engine supporting said APIs. The QoS reservation API, the capacity usage policy API and the QoS prediction API provide the bookkeeper decision engine with an operational connection to the service management and orchestration engine, the capacity usage policy manager and the QoS prediction service, respectively.

It is an advantage of the method according to the invention that a communication network is functionally extended for reserving spectral resources, i.e. resource blocks, in advance. Due to the reservation capability, a terminal device is reliably provided by the communication network with a connection requiring a QoS. A user of the terminal device and a provider of an application or a service accessed by the terminal device pleasantly experience a high quality of the communication network.

Further advantages and configurations of the invention become apparent from the following description and the enclosed drawings.

It shall be understood that the features described previously and to be described subsequently may be used not only in the indicated combinations but also in different combinations or on their own without leaving the scope of the present invention.

The invention is described in detail below with reference to two exemplary embodiments and with reference to the drawings. Like components are indicated by like reference numerals throughout the drawings.

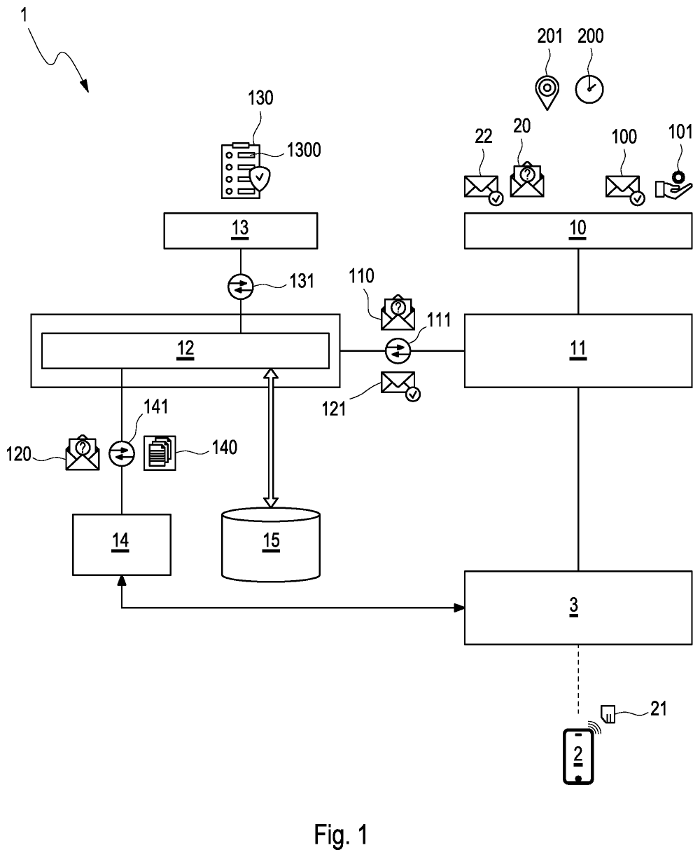

FIG. 1 schematically shows an entity diagram of a resource reservation system 1 according to the invention for a communication network 3. The resource reservation system 1 comprises a business support system 10 and a bookkeeper decision engine 12 and may further comprise a service management and orchestration engine 11 preferably having an QoS reservation API 111, a capacity usage policy manager 13 preferably having a capacity usage policy API 131, a QoS prediction service 14 preferably having a QoS prediction API 141 and a reservation database 15.

Said entities of the resource reservation system 1 may be implemented via a computer program product according to the invention for a computing device. The computer program product comprises a storage medium storing a program code readable by the computing device. The program code causes the computing device to participate in a method for operating the communication network 3 described below as a business support system 10, a service management and orchestration engine 11, a bookkeeper decision engine 12, a QoS prediction service 14 or a capacity usage policy manager 13 of the resource reservation system 1 when being executed by a processor of the computing device.

The program code preferably implements the QoS reservation API 111 for the service management and orchestration engine 11, a capacity usage policy API 131 for the capacity usage policy manager 13 or a QoS prediction API 141 for the QoS prediction service 14, the bookkeeper decision engine 12 supporting said APIs 111, 131, 141.

The resource reservation system 1 is configured for participating in a method according to the invention as follows for operating the communication network 3.

The business support system 10 of the resource reservation system 1 receives a reservation request 20. The reservation request 20 indicates a QoS for an upcoming connection to be provided by a communication network for a terminal device 2 and an application or service accessed by the terminal device 2 via the upcoming connection. The reservation request 20 may further indicate a time 200 of the upcoming connection, a location 201 of the terminal device 2 at the indicated time 200 and/or a number of upcoming connections requiring the indicated QoS.

The business support system 10 has an availability of the indicated QoS for the upcoming connection checked by the bookkeeper decision engine 12 of the resource reservation system 1 and sends a reservation confirmation 100 when the availability of the indicated QoS is confirmed by the bookkeeper decision engine 12.

Having the availability checked may comprise sending an availability request 110 to the bookkeeper decision engine 12 via the service management and orchestration engine 11, the availability request 110 comprising indications of the reservation request 20, and receiving an availability confirmation 121 from the bookkeeper decision engine 12 via the service management and orchestration engine 11 when the bookkeeper decision engine 12 finds an availability of the indicated QoS.

Finding the availability preferably comprises sending a QoS prediction request 120 to a QoS prediction service 14 of the resource reservation system 1 and receiving a QoS prediction report 140 from the QoS prediction service 14, the QoS prediction request 120 comprising indications of the availability request 110 and the QoS prediction report 140 indicating a highest available QoS, a determined number of resource blocks required for the indicated QoS, a number of available resource blocks and a number of free resource blocks at the location 201 of the terminal device 2.

The bookkeeper decision engine 12 or the QoS prediction service 14 may determine the number of resource blocks required for the indicated QoS dependent of the location 201 of the terminal device 2 and a device capability of the terminal device 2 via an estimation or a calculation.

The capacity usage policy manager 13 of the resource reservation system 1 preferably provides the bookkeeper decision engine 12 with a capacity usage policy 130 and the bookkeeper decision engine 12 finds the availability by applying the provided capacity usage policy 130 to the QoS prediction report 140.

Particularly, the capacity usage policy manager 13 selects the capacity usage policy 130 dependent of the indicated application or service and provides the selected capacity usage policy 130.

The bookkeeper decision engine 12 may find the availability when the calculated number of the resource blocks required for the indicated QoS is lower than a predetermined first percentage of free resource blocks and a number of reserved resource blocks is lower than a predetermined second percentage of available resource blocks, the first percentage and the second percentage being defined by availability rules 1300 of the capacity usage policy 130.

The bookkeeper decision engine 12 advantageously stores reservation data corresponding to the indications of the availability request 110 in a reservation database 15 of the resource reservation system 1 first as temporary and second, upon a reservation confirmation 22 received from the business support system 10, as final.

The business support system 10 preferably sends a reservation offer 101 when the availability of the indicated QoS is not confirmed, the reservation offer 101 indicating an available lower QoS for the upcoming connection.

The communication network 3 will provide the upcoming connection with the indicated QoS assigned for the terminal device 2. Assigning the indicated QoS may comprise authorizing the terminal device 2 via a subscriber identity module 21 of the terminal device 2.

The reservation request 20, the reservation confirmation 100 and the reservation offer 101 may be transmitted using a dedicated protocol and/or at a specific QoS.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE NUMERALS

1 resource reservation system
10 business support system (BSS)
100 reservation confirmation
101 reservation offer
11 service management & orchestration (SMO)
110 availability request
111 QoS reservation API
12 bookkeeper decision engine (BDE)
120 QoS prediction request
121 availability confirmation
13 capacity usage policy manager
130 capacity usage policy
1300 availability rule
131 capacity usage policy API
14 QoS prediction engine
140 QoS prediction report
141 QoS prediction API
15 reservation database
2 terminal device
20 reservation request
200 time
201 location
21 subscriber identity module
22 reservation confirmation
3 communication network

1. A method for operating a communication network, comprising:
receiving, by a business support system of a resource reservation system, a reservation request, the reservation request indicating a Quality of Service (QoS) for an upcoming connection to be provided at a time distance from a reservation by the communication network for a terminal device and an application or service accessed by the terminal device via the upcoming connection;
checking, by a bookkeeper decision engine of the resource reservation system, whether the business support system has availability for the indicated QoS;
in response to confirming the availability for the indicated QoS, sending, by the bookkeeper decision engine, a reservation confirmation; and
providing, by the communication network, the upcoming connection with the indicated QoS assigned for the terminal device at the time distance from the reservation.

2. The method according to claim 1, further comprising:
based on availability for a respective indicated QoS not being confirmed, sending, by the business support system, a reservation offer indicating an available lower QoS for a respective upcoming connection.

3. The method according to claim 2, wherein the reservation request, the reservation confirmation, and the reservation offer are transmitted using a dedicated protocol and/or at a specific QoS.

4. The method according to claim 1, wherein the reservation request indicates a time of the upcoming connection, a location of the terminal device at the indicated time, and/or a number of upcoming connections requiring the indicated QoS.

5. The method according to claim 1, wherein checking whether the business support system has availability for the indicated QoS comprises:
sending an availability request to the bookkeeper decision engine via a service management and orchestration engine of the resource reservation system, the availability request comprising indications of the reservation request; and
receiving an availability confirmation from the bookkeeper decision engine via the service management and orchestration engine based on the bookkeeper decision engine finding availability for the indicated QoS.

6. The method according to claim 5, wherein finding availability for the indicated QoS comprises:
sending a QoS prediction request to a QoS prediction service of the resource reservation system; and
receiving a QoS prediction report from the QoS prediction service, the QoS prediction request comprising indications of the availability request and the QoS prediction report indicating a highest available QoS, a determined number of resource blocks required for the indicated QoS, a number of available resource blocks, and a number of free resource blocks at the location of the terminal device.

7. The method according to claim 6, wherein the bookkeeper decision engine or the QoS prediction service determines the number of resource blocks required for the indicated QoS based on the location of the terminal device and a device capability of the terminal device via an estimation or a calculation.

8. The method according to claim 6, wherein a capacity usage policy manager of the resource reservation system provides the bookkeeper decision engine with a capacity usage policy and the bookkeeper decision engine finds availability for the indicated QoS by applying the provided capacity usage policy to the QoS prediction report.

9. The method according to claim 8, wherein the capacity usage policy manager selects the capacity usage policy based on an indicated application or service and provides the selected capacity usage policy.

10. The method according to claim 8, wherein the bookkeeper decision engine finds availability for the indicated QoS based on the calculated number of the resource blocks required for the indicated QoS being lower than a predetermined first percentage of free resource blocks and a number of reserved resource blocks being lower than a predetermined second percentage of available resource blocks, the first percentage and the second percentage being defined by availability rules of the capacity usage policy.

11. The method according to claim 8, further comprising:
implementing a QoS reservation application programming interface (API) for the service management and orchestration engine, a capacity usage policy API for the capacity usage policy manager, or a QoS prediction API for the QoS prediction service;
wherein the implemented API is supported by the bookkeeper decision engine.

12. The method according to claim 5, wherein the bookkeeper decision engine stores reservation data corresponding to the indications of the availability request in a reservation database of the resource reservation system first as temporary and second, upon a reservation confirmation received from the business support system, as final.

13. The method according to claim 1, further comprising:
assigning the indicated QoS, wherein assigning the indicated QoS comprises authorizing the terminal device via a subscriber identity module of the terminal device.

14. A resource reservation system for a communication network, comprising:
one or more processors; and
one or more memories having processor-executable instructions stored thereon;
wherein the one or more processors are configured to execute the processor-executable instructions to facilitate the following being performed:
receiving, by a business support system of the resource reservation system, a reservation request, the reservation request indicating a Quality of Service (QoS) for an upcoming connection to be provided at a time distance from a reservation by the communication network for a terminal device and an application or service accessed by the terminal device via the upcoming connection;
checking, by a bookkeeper decision engine of the resource reservation system, whether the business support system has availability for the indicated QoS;
in response to confirming the availability for the indicated QoS, sending, by the bookkeeper decision engine, a reservation confirmation; and
providing, by the communication network, the upcoming connection with the indicated QoS assigned for the terminal device at the time distance from the reservation.

15. One or more non-transitory computer-readable mediums having processor-executable instructions stored thereon, wherein the processor-executable instructions, when executed, facilitate:
receiving, by a business support system of a resource reservation system, a reservation request, the reservation request indicating a Quality of Service (QoS) for an upcoming connection to be provided at a time distance from a reservation by the communication network for a terminal device and an application or service accessed by the terminal device via the upcoming connection;
checking, by a bookkeeper decision engine of the resource reservation system, whether the business support system has availability for the indicated QoS;
in response to confirming the availability for the indicated QoS, sending, by the bookkeeper decision engine, a reservation confirmation; and
providing, by the communication network, the upcoming connection with the indicated QoS assigned for the terminal device at the time distance from the reservation.

16. The one or more non-transitory computer-readable mediums according to claim 15, wherein the processor-executable instructions, when executed, further facilitate:
implementing a QoS reservation application programming interface (API) for a service management and orchestration engine, a capacity usage policy API for a capacity usage policy manager, or a QoS prediction API for a QoS prediction service;
wherein the implemented API is supported by the bookkeeper decision engine.
